(19) United States
(12) Patent Application Publication
(10) Pub. No.: US 2006/0269257 A1
(43) Pub. Date: Nov. 30, 2006

(54) Recording method, recording apparatus, and playback apparatus using single-sided multi-layer optical disc

(76) Inventor: Masao Kubo, Kawagoe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/434,248

(22) Filed: May 16, 2006

(30) Foreign Application Priority Data
May 17, 2005 (JP) 2005-143787

(51) Int. Cl. H04N 5/00

(52) U.S. Cl. 386/125

(57) ABSTRACT

In recording using a DVD-R•DL medium (single-sided, dual-layer write-once optical disc), log management of recording is implemented in an intermediate state before finalization, and playback compatibility to the existing format (VR mode of DVD-R/RW, etc.) is assured after finalization. To this end, a VAT (Virtual Allocation Table) specified by the DVD-R (VR) standard is used in the intermediate state of the DVD-R•DL medium. With this configuration, the DVD-R•DL medium can implement log management of the DVD-R (VR) standard. By rewriting the volume and file structure in correspondence with the DL standard, compatibility with a player which can play back DVD-RAM (VR) media, etc. is assured.

### CROSS-REFERENCE TO RELATED APPLICATIONS

This application is based upon and claims the benefit of priority from Japanese Patent Application No. 2005-143787, filed May 17, 2005, the entire contents of which are incorporated herein by reference.

### BACKGROUND

1. Field

One embodiment of the invention relates to an improvement in a method of recording on a single-sided information recording medium. For example, one embodiment of the invention relates to a method and apparatus which allow efficient use of a standardized write-once medium (single-sided, dual-layer DVD-R disc or the like) which undergoes finalization processing as needed.

2. Description of the Related Art

The recording format of digital versatile discs (DVD) includes the DVD-Video format used in sell-distributed DVD software and the like and the DVD-VR format which is used in DVD recorders and allows edit processing. Conventionally, the DVD-VR format is mainly used in a DVD-RAM and DVD-RW (for example, see Jpn. Pat. Appln. KOKAI Publication No. 9-259538).

The DVD-RAM and DVD-RW are rewritable media, and are convenient for edit processing but the per-price cost of the media is high. By contrast, DVD-R media are relatively inexpensive. Conventionally, in view of playback compatibility with DVD players, video recording in the DVD-Video format predominates in the DVD-R. Also, video recording on the DVD-R in the DVD-VR format is officially admitted as a standard for the DVD format.

In recent years, to meet a requirement for larger capacities, single-sided, dual-layer discs (DVD±R•DL, DVD±RW•DL, etc.: DL is an abbreviation for Dual Layer) have been developed in addition to conventional single-sided, single-layer discs (DVD±R, DVD±RW, etc.), and their spread is greatly expected in the future (multi-layer optical discs will be developed and put into the market in the near future).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for explaining an overview of a video recording apparatus according to one embodiment of the invention;

FIG. 2 is an exemplary view for explaining the relationship between management information and actual video data;

FIG. 3 is an exemplary schematic view for explaining an example of the configuration of directories and files specified by the DVD video recording standard (DVD-VR standard);

FIG. 4 is an exemplary flowchart for explaining an example of video recording processing in the video recording apparatus according to one embodiment of the invention;

FIG. 5 is an exemplary view for explaining an example of transition of a recordable area when video recording is done on a DVD-R disc in the DVD-VR format;

FIG. 6 is an exemplary view showing a practical example of log information (VAT_ICB with VAT) recorded at the end of each zone in the recordable area shown in FIG. 5;

FIG. 7 is an exemplary view for explaining the state of a write-once medium after initialization;

FIG. 8 is an exemplary view for explaining the state of a write-once medium used in recording after initialization;

FIG. 9 is an exemplary view for explaining an example of the format of a single-sided, dual-layer DVD-R (DVD-R•DL );

FIG. 10 is an exemplary flowchart for explaining an example of the format processing of the DVD-R•DL;

FIG. 11 is an exemplary flowchart for explaining a processing example in an intermediate state (before finalization) in video recording and edit processing using the DVD-R•DL;

FIG. 12 is an exemplary flowchart for explaining an example of finalization processing of the DVD-R•DL;

FIG. 13 is an exemplary view for explaining an example of the file structure of the DVD-R•DL (VR mode) before finalization;

FIG. 14 is an exemplary view for explaining an example of the file structure (corresponding to that of the DVD-RAM/VR mode) of the DVD-R•DL (VR mode) after finalization;

FIG. 15 is an exemplary view for explaining another example of the format of a single-sided, dual-layer DVD-R (DVD-R•DL);

FIG. 16 is an exemplary view for explaining an example of the volume structure of the single-sided, dual-layer DVD-R (DVD-R•DL); and

FIG. 17 is an exemplary view for explaining a rewrite example of a first anchor point of the single-sided, dual-layer DVD-R (DVD-R•DL).

### DETAILED DESCRIPTION

Various embodiments according to the invention will be described hereinafter with reference to the accompanying drawings.

In general, one embodiment according to the invention can record video information on a write-once medium such as a single-sided, dual-layer DVD-R or the like (single-sided, multi-layer information recording medium in a broader sense) in a video recording format such as the DVD-VR format or the like that allows easy edit processing.

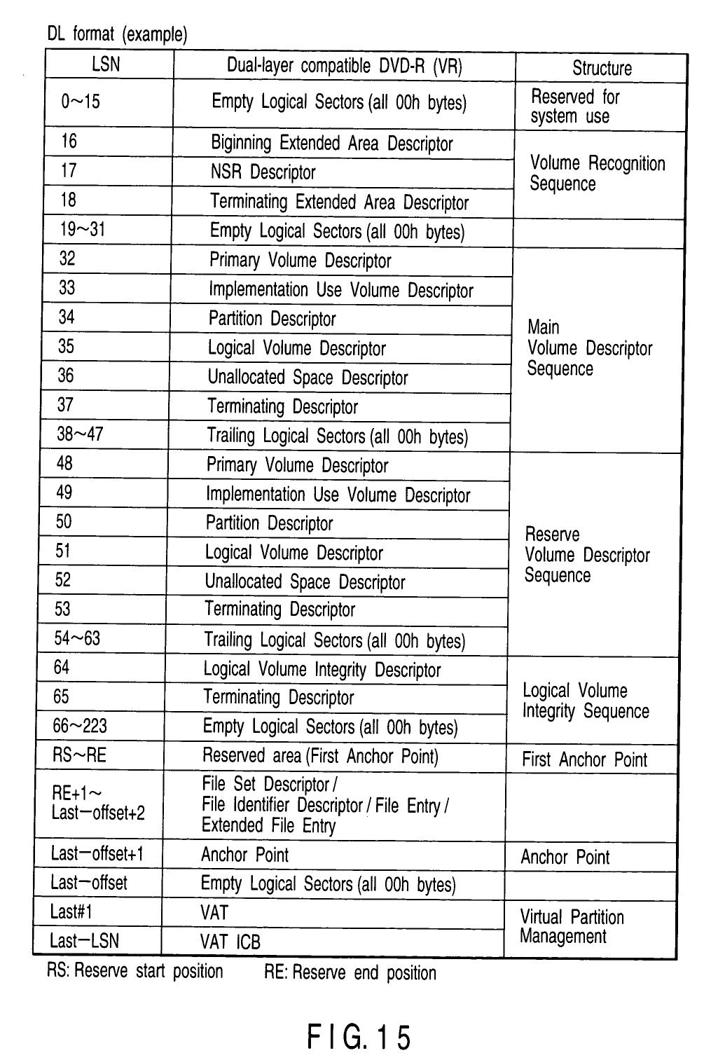

A recording method according to one embodiment of the invention is a method for performing digital recording on an optical disc (in a format with an excellent edit function such as the DVD-VR format) comprising a single-sided, multi-layer recordable area which can include a volume structure & file structure area and one or more recordable zones between a lead-in area and lead-out area. In this method, formatting is made to assure a reserved area used to write anchor point information (for instance, RS to RE in FIG. 15 including position LSN=256 where anchor point information is written in case of a single-sided, single-layer medium). A temporary anchor point area (Last-offset+1) that stores anchor point information in an intermediate state before finalization may be assured at a position other than this reserved area (this temporary anchor point area is not defined in the case of the single-sided, single-layer medium).

Note that anchor point information is recorded in the temporary anchor point area in the intermediate state of, e.g., single-sided, dual-layer recording. Then, the anchor point information in the temporary anchor point area (Last-offset+1) may be configured to be written in the reserved area (RS to RE in FIG. 15) (by finalization processing or the like).

Note that the “anchor point” may indicate one of specific sets of logical sector numbers (LSN), and may be configured to record a descriptor which specifies an extent (a set of logical sectors or logical blocks) of a volume descriptor sequence (a sequence including description information associated with a volume).

Log management upon recording on a single-sided, single-layer DVD-R in the format (more specifically, DVD-VR format) with a variety of edit functions is also allowed in a single-sided, dual-layer DVD-R. In this case, since anchor point information is temporarily saved in the temporary anchor point area in the intermediate state (before finalization), the contents of the temporarily saved anchor point information can be written in a regular anchor point area (reserved area) upon finalization. In this way, compatibility with a player which can play back, e.g., a DVD-RAM/±RW/±R (VR mode) can be guaranteed after finalization.

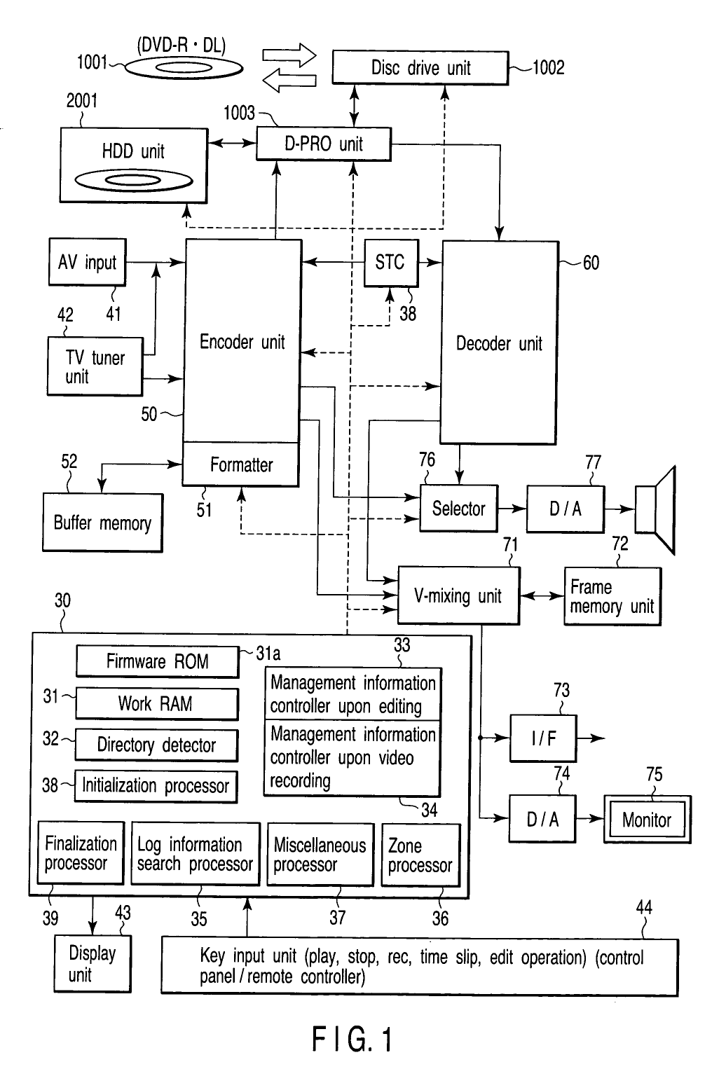

One embodiment of the invention will be described hereinafter with reference to the accompanying drawings. FIG. 1 is a block diagram showing one embodiment of a video recording apparatus to which the invention is applied. This embodiment shows an apparatus (a DVD-VR recorder with an HDD) which can handle both an optical disc such as a DVD-R or the like and a hard disk as recording media. Also, a semiconductor memory or the like may be used together as the recording medium. When blocks in FIG. 1 are roughly classified, the left side shows principal blocks of a recording unit, and the right side shows principal blocks of a playback unit.

The video recording apparatus shown in FIG. 1 has two different disc drive units. The apparatus has disc drive unit 1002 which drives optical disc (DVD-RAM, DVD±RW, DVD±R, or the like) 1001 as a first medium which is an information recording medium that can form a video file, and executes read/write accesses of information. Also, the apparatus has hard disc drive (HDD) unit 2001 which drives a hard disk (HD) as a second medium. Data processor unit 1003 can supply recording data to disc drive unit 1002 and HDD unit 2001, and can receive playback signals. Disc drive unit 1002 has a rotation control system, laser drive system (which uses a red laser of a wavelength of 650 nm or a blue laser of a wavelength of 405 nm or less), optical system, and the like for optical disc 1001. Data processor unit 1003 handles data in recording or playback units, and includes a buffer circuit, modulation and demodulation circuit, error correction unit, and the like.

The video recording apparatus shown in FIG. 1 includes encoder unit 50 that forms the video recording side, decoder unit 60 that forms the playback side, and microcomputer block 30 that controls the operation of the apparatus main body as principal building components. Encoder unit 50 has video and audio analog-to-digital converters which convert an input analog video signal and input analog audio signals into digital signals, a video encoder, and an audio encoder. Furthermore, encoder unit 50 includes a sub-picture encoder. The output from encoder unit 50 is converted into a predetermined DVD-RAM format by formatter 51 which includes a buffer memory, and the converted data is supplied to data processor unit 1003 above. Encoder unit 50 receives an external analog video signal and external analog audio signal from AV input unit 41 or an analog video signal and analog audio signal from TV tuner unit 42.

Note that encoder unit 50 can directly supply a compressed digital video signal and digital audio signal to formatter 51 when it directly receives the compressed digital video signal and digital audio signal. Encoder unit 50 can also directly supply an analog-to-digital converted digital video signal and audio signal to video mixing unit 71 and audio selector 76. The video encoder included in encoder unit 50 converts a digital video signal into a compressed digital video signal based on the MPEG2 (or MPEG1 or MPEG4-AVC) standard. A digital audio signal is converted into a digital audio signal compressed at a fixed bit rate based on the MPEG or AC-3 standard, or into a linear PCM digital audio signal.

When a sub-picture signal is input from AV input unit 41 (e.g., a signal from a DVD video player with an independent output terminal of a sub-picture signal), or when a DVD video signal with such data format is broadcasted and is received by TV tuner unit 42, the sub-picture signal in the DVD video signal is encoded by the sub-picture encoder (by runlength coding) to obtain a sub-picture bitmap. The encoded digital video signal, digital audio signal, and sub-picture data are packed by formatter 51 as video packs, audio packs, and sub-picture packs. Furthermore, these packs are collected and are converted into the format (DVD-Video format) specified by the DVD-Video standard or the format (DVD-VR format) specified by the DVD-recording standard.

The apparatus shown in FIG. 1 supplies information (video packs, audio packs, sub-picture packs, and the like) and management information which are respectively formatted and generated by formatter 51 to HDD unit 2001 or disc drive unit 1002 via data processor unit 1003, and can record them in the HD or optical disc 1001. Also, the apparatus can record information recorded in the HD or optical disc 1001 in optical disc 1001 or the HD via data processor unit 1003 and disc drive unit 1002. Furthermore, the apparatus can execute edit processing for deleting some of video objects of a plurality of programs recorded in the HD or optical disc 1001, joining objects of different programs, and so forth. This is because the DVD-VR format exploited in one embodiment of the invention defines a data unit to be handled and facilitates edit processing.

Microcomputer block 30 includes an MPU (microprocessing unit) or CPU (central processing unit), a firmware ROM in which control programs and the like (firmware that implements control described in respective flowcharts, and the like) are written, a work RAM that provides a work area used to execute programs, and the like. The MPU of microcomputer block 30 executes defective location detection, unrecorded area detection, video recording information recording position settings, UDF recording, AV address settings, log information search processing, and the like in accordance with the control programs stored in the ROM using the RAM as a work area.

More specifically, microcomputer block 30 has information processors needed to control the entire system. That is, microcomputer block 30 comprises a VMG information (entire video management information) generator, copy related information detector, copy & scrambling information processor (RDI processor), packet header processor, sequence header processor, aspect ratio information processor, and the like (although none of them are shown) in addition to firmware ROM 31a, work RAM 31, and directory detector 32. Furthermore, microcomputer block 30 comprises processor 36 that performs processing of a zone (RZone), processor 35 that conducts a log information search, controller 34 of management information upon executing video recording, controller 33 of management information upon executing edit processing, initialization (formatting) processor 38 of a single-sided, dual-layer (single-sided, multi-layer) recordable optical disc (DVD-R/±R, DVD-RW/±RW, or the like), finalization processor 39 of the single-sided, dual-layer (single-sided, multi-layer) recordable optical disc, and the like. Note that miscellaneous processor 37 performs processing for returning a partially used disc to an initialized state and the like.

Of the execution results of the MPU, those that the user is notified of are displayed on display unit 43 of the video data recording and playback apparatus, or are displayed on monitor display 75 as OSD (on-screen display) data. Microcomputer block 30 has key input unit 44 used to input operation signals for operating this apparatus. This key input unit 44 corresponds to, for example, operation switches provided on the main body of the video recording apparatus, or a remote controller device or the like. Input unit 44 may comprise a personal computer which is connected to the video recording apparatus according to one embodiment of the present invention via arbitrary communications such as a wired communication, wireless communication, optical communication, infrared ray communication, and the like. In any of these forms, the user can execute video recording processing of input AV signals, playback processing of recorded contents, edit processing for the recorded contents, and the like by operating this key input unit 44.

Note that the timings at which microcomputer block 30 controls HDD unit 1002, disc drive unit 2001, data processor unit 1003, encoder unit 50 and/or decoder unit 60, and the like can be determined based on time data from STC (system time clock) 38. Video recording and playback operations are normally executed in synchronism with time clocks from STC 38. However, other processes may be executed at timings independently of STC 38.

Decoder unit 60 has a separator which separates respective packs from a signal of the DVD format having the pack structure, a memory used upon execution of pack separation and other kinds of signal processing, a V decoder which decodes main picture data (contents of video packs) separated by the separator, an SP decoder which decodes sub-picture data (contents of sub-picture packs) separated by the separator, and an A decoder which decodes audio data (contents of audio packs) separated by the separator. Also, decoder unit 60 comprises a video processor which mixes decoded sub-picture data with decoded main picture data and outputs sub-picture data such as a menu, highlight button, subtitle, and the like to be superimposed on main picture data.

The output video signal of decoder unit 60 is input to video mixing unit 71. Video mixing unit 71 mixes text data. To video mixing unit 71, a line used to directly fetch signals from TV tuner 42 and A/V input unit 41 is also connected. Frame memory 72 used as a buffer is connected to video mixing unit 71. When the output from video mixing unit 71 is an analog output, it is externally output via I/F (interface) 73. When the output from video mixing unit 71 is a digital output, it is externally output via digital-to-analog converter 74.

The output audio signal of decoder unit 60 is converted into an analog signal by digital-to-analog converter 77 via selector 76, and the analog audio signal is externally output. Selector 76 is controlled by a select signal from microcomputer block 30. In this way, selector 76 can directly select a signal which is output through encoder unit 50 when it directly monitors a digital signal from TV tuner 42 or A/V input unit 41.

Note that formatter 51 of encoder unit 50 generates segmentation information during video recording, and periodically sends it to the MPU of microcomputer block 30 (information upon GOP head interrupt or the like). The segmentation information includes the number of packs of a VOBU, the end address of I-picture data from the head of the VOBU, the VOBU playback time, and the like. At the same time, formatter 51 sends information from the aspect ratio information processor to the MPU at the beginning of video recording, and the MPU generates VOB stream information (STI). The STI in this case saves resolution data, aspect data, and the like, and the respective decoders undergo initial settings based on this information upon playback.

In the apparatus shown in FIG. 1, one video file is stored per disc. Also, in order to continue playback without disconnection during data access (seek), a minimum contiguous information unit (size) is determined. This unit is called a CDA (contiguous data area). The CDA size is a multiple of ECC (error correction code) blocks (16 sectors), and the file system records using this CDA unit.

Data processor 1003 receives data in VOBU units from the formatter of encoder unit 50, and supplies data in CDA units to disc drive unit 1002 or HDD unit 2001. The MPU of microcomputer block 30 generates management information needed to play back recorded data, and sends the generated management information to data processor unit 1003 when it recognizes a data recording end command. In this way, the management information is recorded in the disc. Therefore, the MPU of microcomputer block 30 receives information (segmentation information, etc.) in data units during encoding. The MPU of microcomputer block 30 recognizes management information (file system) read from the optical disc and HD at the beginning of recording, recognizes unrecorded areas of these discs, and sets a recordable area in terms of data on the discs via data processor unit 1003.

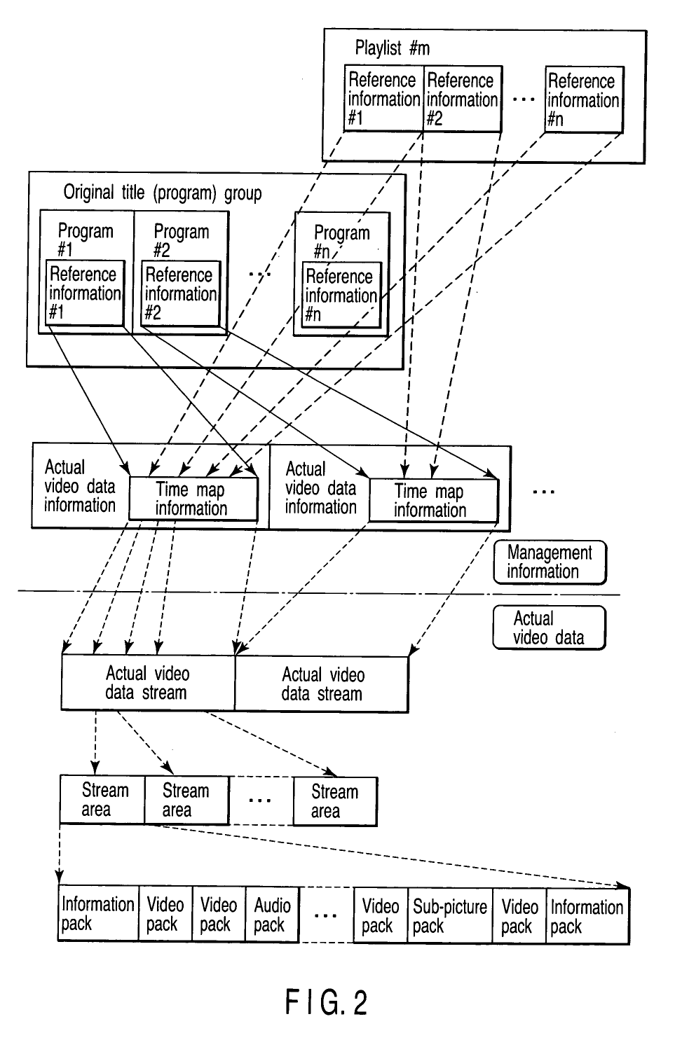

The relationship between management information and actual video data as contents will be briefly described below with reference to FIG. 2. Actual video data will be described first. Assume that actual video data are combined into one file on a recording medium. One file includes one or a plurality of actual video data streams. Each individual actual video data stream is often a unit recorded by single video recording processing. This corresponds to, for example, a VOB (video object) in the DVD-VR standard. Each actual video data stream includes one or a plurality of stream areas. Such stream area corresponds to, for example, a VOBU (video object unit) in the DVD-VR standard, a GOP (group of picture) in the MPEG2 standard, or the like. One stream area includes a plurality of packs. As the plurality of packs, information packs, video packs, audio packs, and the like exist. Sub-picture packs may also be included.

Each information pack corresponds to, for example, an RDI pack or the like in the DVD video recording (DVD-VR) standard. In this case, this pack includes information indicating the playback time at which the first field of a VOBU to which that pack belongs is to be played back, information indicating the recording time of the VOBU of interest, manufacturer information (MNFI), and the like. Also, this pack includes display control information (DCI) and copy control information (CCI). The display control information indicates aspect ratio information, subtitle mode information, and film camera mode information. The copy control information includes copy permission information or copy inhibition (non-permission) information.

Each video pack corresponds to video data compressed by MPEG2, and includes a pack header, packet header, and video data field. Each audio pack corresponds to audio data processed by, e.g., linear PCM, MPEG, AC-3, or the like, and includes a pack header, packet header, and audio data field.

The management information will be described below. In the management information, original title (program) information as information that manages the playback order of actual video data (playback order information) is defined. This information corresponds to, for example, a program or the like in the DVD-VR standard. In each individual original title information (or program information), reference information is defined. This reference information is linked with actual video data information as information associated with actual video data to be played back. This information corresponds to, for example, video object information (VOBI) in the DVD-VR standard. In this way, an original title (program) has information that manages the playback order (playback order information) and its own actual video data, and this title is normally generated upon video recording.

By contrast, management information which includes only information that manages the playback order (playback order information) is also available. This is playlist information, and corresponds to, for example, a playlist in the DVD-VR standard. This playlist information does not have any own actual video information, and is generated as a playlist by editing (deleting or adding) reference information which is linked with actual video data information of the original title, as shown in FIG. 2.

The actual video data information may describe time map information. This time map information may designate an area which forms the actual video data stream corresponding to the actual video data information. A link from the reference information of the original title information or playlist information of the management information to actual video data information is specified by a logical address. A link from the time map information to the actual video data stream and its areas may be specified based on the actual data stream number, the number of areas in that stream, the entry numbers corresponding to individual areas, and logical addresses to individual areas. With this configuration, not only normal playback of recorded video data but also special playback such as double-speed or slow playback or reverse playback, a scene search, and the like are supported.

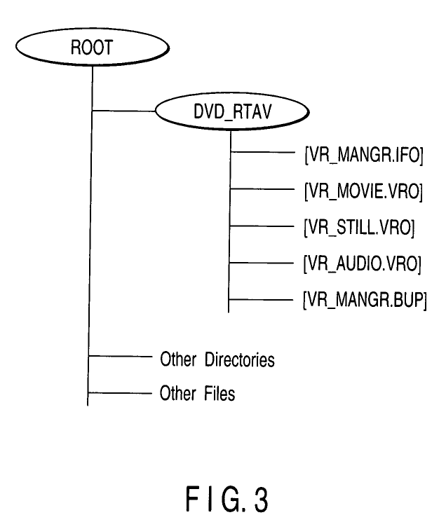

The operation of one embodiment of the invention will be described below with reference to FIG. 3 and the subsequent figures. In the following description, assume that the video recording apparatus according to one embodiment of the invention adopts the following arrangement. That is, this video recording apparatus is a DVD video recording apparatus based on the DVD video recording standard (DVD-VR standard). In this case, video recording is done in a data format called the DVD-VR format on a DVD disc (normally, a DVD-RAM disc or DVD-RW disc; it is also possible to perform video recording on a DVD-R disc). In addition, this video recording apparatus also has a function of recording on a DVD disc based on the DVD video standard (DVD-Video standard). In this case, video recording is done on a DVD disc (DVD-R disc or the like) in a data format called the DVD-Video format.

The video recording apparatus according to one embodiment of the invention can use not only a rewritable DVD-RAM disc or DVD-RW disc but also a DVD-R disc as a write-once medium. The formats used to carry out video recording on these DVD discs are not uniquely determined depending on the types of DVD discs, but video recording can be carried out on, e.g., a DVD-R disc using either the DVD-VR format or the DVD-Video format.

In the following description, assume that the video recording apparatus according to one embodiment of the invention is a hybrid video recorder which has two video recording media, i.e., a DVD and HDD, as shown in the block diagram of FIG. 1 mentioned above, and allows dubbing (or move) of video information between the DVD and HDD. However, the contents of one embodiment of the invention are applied not only to the hybrid video recorder, but also to a DVD dedicated video recorder having only a function for recording video onto DVD discs (including a personal computer which serves as a DVD recorder by means of software).

In the video recording apparatus according one embodiment of the invention, a partial area in the recorded title may be called a chapter. For example, in the case of video recording in the DVD-VR format, a chapter uses, as a marker of its boundary, an entry point (EP) which is set in the title and is defined in the DVD-VR standard. That is, a section sandwiched between a given EP and the next EP set in the title is called a chapter. Note that the start and end points of the title are defined as boundaries of chapters irrespective of the presence/absence of EPs. Therefore, as for the first chapter of the title, no EP is set at its start point in some cases.

FIG. 3 is an exemplary schematic view showing the configuration of directories and files specified by the DVD video recording standard (DVD-VR standard). FIG. 3 exemplifies directories and files specified by the DVD-VR standard Verl.l. Under a root directory, a subdirectory DVD_RTAV is assured, and files specified by the standard are stored under this DVD_RTAV. That is, only five types of files shown in FIG. 3 exist under the DVD_RTAV. Individual files will be explained below.

VR_MANGR.IFO is navigation data for an original title (program) or playlist. This file corresponds to management information shown in FIG. 2 described above. A playlist, entry points (EP), and the like are described in this VR_MANGR.IFO. By changing the description of the VR_MANGR.IFO in place of directly processing video data, edit processing such as deletion of an unwanted scene and the like can be applied. Therefore, when edit processing such as creation of a chapter, editing of a playlist and the like is applied, this VR_MANGR.IFO is to be mainly processed. In this VR_MANGR.IFO, time map information for actual video data is written in synchronism with video recording. Since information that pertains to the entire disc is also written in this VR_MANGR.IFO, the VR_MANGR.IFO is created immediately after the DVD disc is initialized.

VR_MANGR.BUP is a backup file of the VR_MANGR.IFO. This VR_MANGR.BUP is an option in the standard, and does not always exist. If the VR_MANGR.BUP is used, the contents of that file have to be the same as those of the VR_MANGR.IFO.

On the other hand, VR_MOVIE.VRO is an AV (Audio Visual) data file of recorded moving picture data, and corresponds to actual video data shown in FIG. 2 described above. This file stores video data, audio data, and sub-picture data (if it is supported), which are packed and multiplexed. A VR_STILL.VRO file is an AV data file of still picture data, and corresponds to actual video data in FIG. 2 described above as in the VR_MOVIE.VRO. This file stores packed video data, and also stores multiplexed audio data and sub-picture data as an option in some cases. A VR_AUDIO.VRO file is a data file which stores post-recording audio information for the still picture data stored in the VR_STILL.VRO file.

The VR_MOVIE.VRO, VR_STILL.VRO, and VR_AUDIO.VRO files do not exist after initialization of the DVD disc, and are created to record video data and audio data when video recording is actually done. Note that these three types of files do not always exist, and the VR_STILL.VRO or VR_AUDIO.VRO file does not exist in a video recording apparatus which does not have a still picture recording function or after-recording function.

The files specified in the DVD-VR standard Ver1.1 have been described. In addition, to improve the operability and addition of functions of the video recording apparatus, it is possible to create information files unique to that video recording apparatus. In this case, these unique information files are not stored under the DVD_RTAV, but are stored under a unique subdirectory created under the root directory.

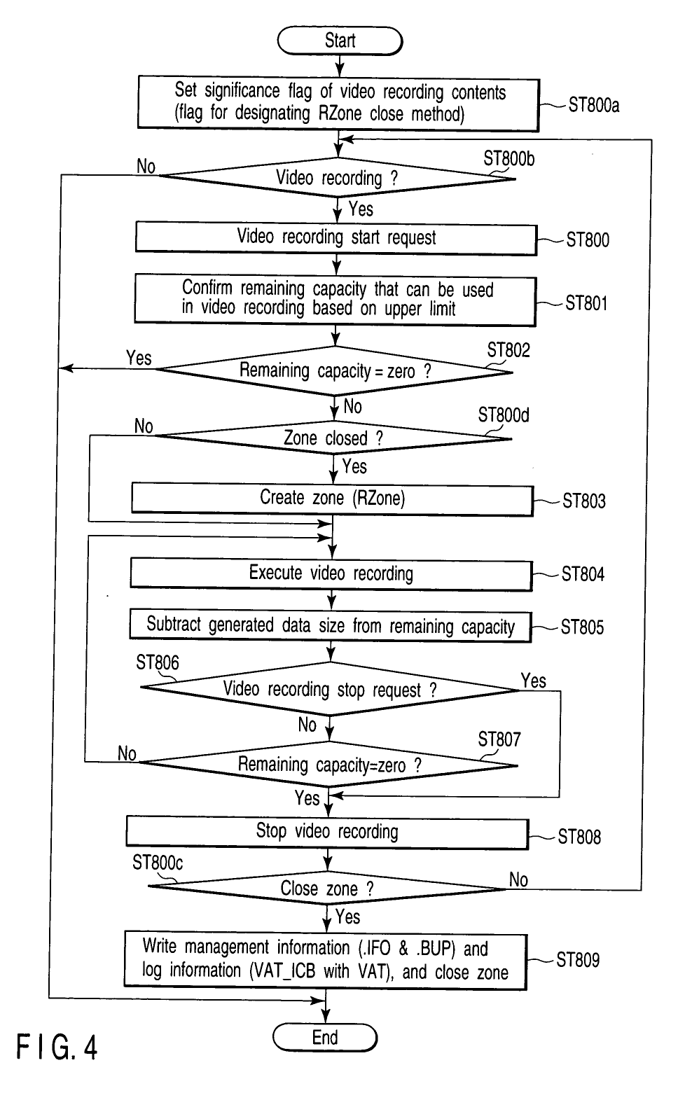

FIG. 4 is a flowchart for explaining an overview of video recording processing in the video recording apparatus according to one embodiment of the invention. When this processing starts, a user menu or dialog box (not shown) is displayed as OSD (on-screen display) data on the screen of monitor 75 in FIG. 1 or the like (block ST800a). This OSD display is configured to allow the user to make a flag setting depending on the significance of contents (broadcast program or the like) to be recorded after this.

More specifically, the user can select a flag indicating significant contents (e.g., flag “11”; a default setting) or a flag indicating that the capacity saving takes priority over the certainty of video recording storage (e.g., flag “01”, “10”, or “00”) by operating cursor keys and an enter key on a remote controller (not shown). The flag selected by the user is temporarily stored in, e.g., a memory (work RAM 31 or the like) in MPU 30 shown in FIG. 1. If the user selects nothing (default) or selects the flag indicating the significant contents by his or her intention (flag “11” in this case), a zone (RZone) used in that video recording is certainly closed at the end of video recording later (YES in block ST800c; as a result, an RMA area and recording area of the disc are partially consumed upon zone closing in every video recording).

On the other hand, if the user selects the flag that gives priority to the capacity saving of the disc in use, he or she can also select a case of only the flag (“00”) indicating that “a zone (RZone) used in that video recording is not closed at the end of video recording” (NO is always determined in block ST800c unless the user issues a zone close command), and can further select the following detailed contents.

That is, the user can select via a user menu or the like a flag (“01”) indicating that a zone (RZone) used in last video recording is closed once every n-th end of video recording (n is an integer equal to or larger than 1)” or a flag (“10”) indicating that a zone (RZone) used in last recording is closed once every n-th end of video recording when the remaining capacity of the disc in use becomes m % (e.g., when the unused disc capacity becomes only 30%) (m is an integer ranging from 1 to 99)”. Note that the user can arbitrarily initially set n and m using a remote controller or the like, or the apparatus of FIG. 1 determines n and m in advance as default values. For example, when n=2 and m=30 are set, if the user selects the flag “01”, a zone is closed once per two video recording operations (the RMA area and recording area to be consumed upon closing the zone are saved for one video recording operation) irrespective of the remaining capacity of the disc. If the user sets the flag “10”, when the remaining capacity of the disc is 31% or more, a zone is closed every end of video recording. However, when the remaining capacity becomes 30% or less (detected in, e.g., block ST807), a zone is closed once per two video recording operations (the RMA area and recording area to be consumed upon closing the zone are saved only when the remaining capacity becomes small).

After the user sets the flag (or after the user sets nothing, i.e., he or she selects the default setting “11”), if he or she presses a video recording button on the remote controller (not shown) or programmed video recording starts based on a video recording programming timer (YES in block ST800b), a video recording start request is called (block ST800). Next, the remaining capacity of a recording area that can be used in video recording is checked (block ST801). In block ST802, the processing branches by seeing if the remaining capacity that can be used in video recording is substantially zero prior to the beginning of actual video recording. If the remaining capacity that can be used in video recording is substantially zero (not only the case in which the remaining capacity is strictly zero but also the case in which the remaining capacity will become completely zero in a few minutes even when the video recording starts can be included in the case of substantially zero), a series of processes end without executing the subsequent video recording processing.

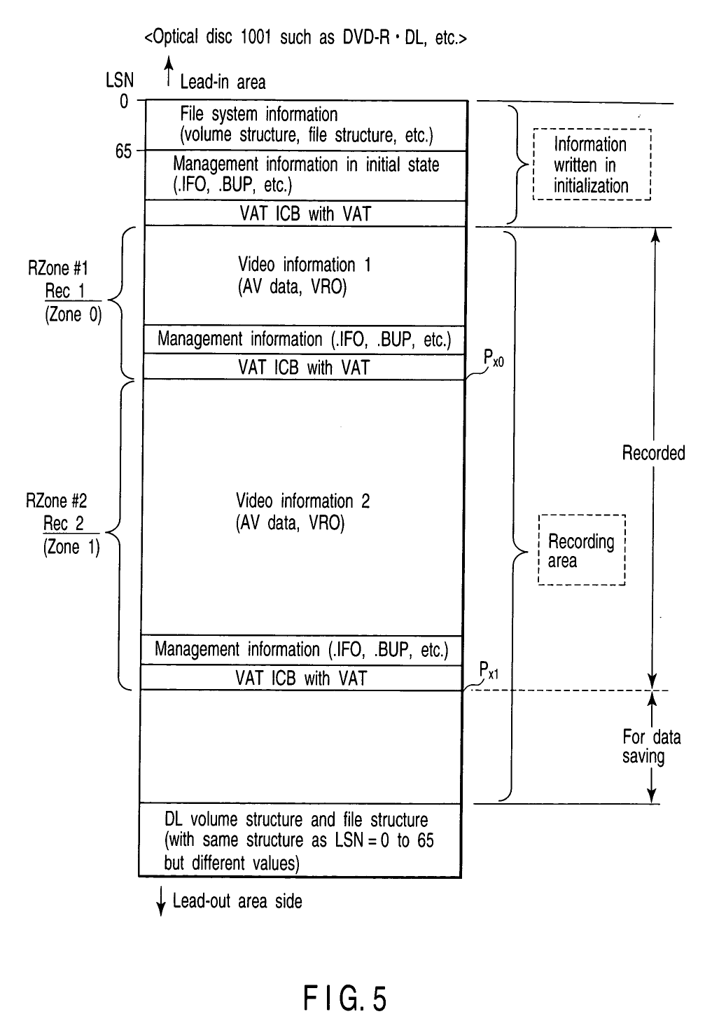

On the other hand, if the remaining capacity that can be used in video recording is not zero, it is checked if a zone is closed at that time (block ST800d). If the zone is closed (YES in block ST800d), a zone for recording AV data (realtime data) shown in, e.g., FIG. 5 and the like is created on a recording area of the disc (block ST803), and the flow advances to block ST804 to start video recording. If a zone is not closed at the time after the remaining capacity checking in block ST802 (NO in block ST800d after NO in block ST800c), the control skips block ST803 and jumps to video recording processing in block ST804 (this corresponds to, e.g., processing for starting recording of realtime data without closing that zone after recording realtime data and a change file/VAT_ICB).

Note that processes in subsequent blocks ST804 to ST807 are mainly video recording and checking of the remaining capacity. In these blocks, the remaining capacity is checked while performing video recording. Since video recording and remaining capacity checking are alternately executed in very small time units, they are almost parallelly executed from a macroscopic viewpoint. That is, video recording processing is executed in block ST804. In block ST805, the capacity of data generated by video recording is subtracted from the remaining capacity of the recording area. It is monitored in block ST806 if a video recording stop request is called. Such video recording stop request is called when, for example, the user stops manual video recording by a direct operation, programmed video recording is stopped based on the timer setting, the user stops programmed video recording by his or her operation halfway through, or the like. If it is determined that the video recording stop request is called, the control skips next block ST807, and jumps to block ST808. If it is determined that no video recording stop request is called, the control advances to block ST807.

In block ST807, the remaining capacity obtained by subtracting the data capacity generated by video recording in block ST805 is checked to see if the capacity needed to continue video recording still remains, thus branching the processing. If it is determined that the remaining capacity is zero, the flow advances to block ST808. On the other hand, if the remaining capacity is not zero, the flow returns to block ST804 to continue video recording by repeating the processes in blocks ST804 to ST807. In block ST808, video recording is stopped by determining that the remaining capacity becomes zero or the video recording stop request is called, thus ending a series of processes.

Next, it is checked if the zone that has undergone a series of video recording operations is to be closed (block ST800c). This checking block is made based on the flag (“11”, “01”, “10”, or “00”) set in block ST800a. That is, if the flag is, e.g., “00”, even if video recording is stopped in block ST808, the flow returns to block ST800b without closing that video recording zone. (However, even when the flag is “00”, if the user inputs a zone close command by operating the remote controller, that video recording zone is closed.) On the other hand, for example, if n=2 and the flag is “01”, the zone is not closed in the first video recording processing in blocks ST800 to ST808 (NO in block ST800c) but that zone is closed in the second video recording processing (YES in block ST800c, ST809).

Such “zone close processing once per n times” can be implemented as follows. That is, a counter (register) in which a numeral value of n is preset is provided in MPU 30 in FIG. 1. This counter is counted down one by one every video recording processing, and when the count value becomes zero, the numerical value of n is preset again in the counter after the zone close processing block ST809 is executed.

Furthermore, for example, if n=5, m=30, and the flag is “10”, when the remaining capacity is 31% or more, the video recording zone is closed all the time in block ST809 if it is determined in block ST808 that the video recording is stopped. On the other hand, if the remaining capacity becomes 30% or less, the zone is not closed (NO in block ST800c) in the first to fourth video recording processes in blocks ST800 to ST808, but it is closed in the fifth video recording process (YES in block ST800c, block ST809). (Note that whether or not the remaining capacity becomes m=30% can be confirmed in block ST807 or ST801.) If the flag set in block ST800a is “11”, the video recording zone is closed all the time irrespective of the settings of n and m if it is determined in block ST808 that the video recording is stopped.

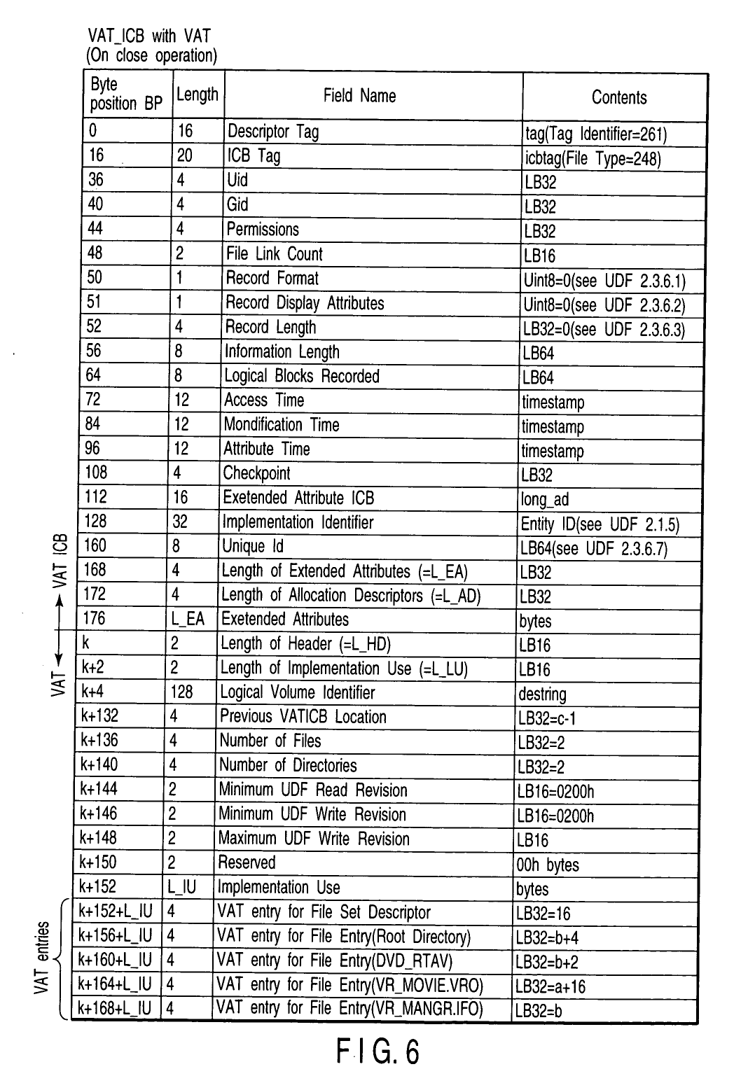

In this way, the zone that has undergone a series of video recording operations is closed. If the video recording processing ends and the video recording zone is to be closed (YES in block ST800c), management information (VR_MANGR.IFO and its backup file (VR_MANGR.BUP) in FIG. 3) corresponding to the video recorded contents is generated, and log information (“VAT_ICB with VAT” to be described later with reference to FIG. 6) is written at the end of the zone in block ST809.

For example, in the case of the example of FIG. 5 (DVD-VR format recording using a DVD-R disc), if a series of video recording operations correspond to “Rec 1” of zone 0, video information 1 (VRO file information of AV data) is recorded from the lead-in side of zone 0, management information (VR_MANGR.IFO and VR_MANGR.BUP) is recorded at the end side of zone 0, and log information (VAT_ICB with VAT) is recorded at the end of that zone 0. The end position (Pₓ₀) of zone 0 can be indicated by, e.g., an address generated in correspondence with the recorded information length of “Rec 1” from the head of zone 0. This address (end position Pₓ₀ of zone 0) can be written in the log information (VAT_ICB with VAT) recorded at the end of zone 0.

Likewise, if a series of video recording operations in blocks ST804 to ST807 in FIG. 4 correspond to “Rec 2” of zone 1 in FIG. 5, video information 2 (VRO file information of AV data) is recorded immediately after end position Pₓ₀ of zone 0, management information (VR_MANGR.IFO and VR_MANGR.BUP) is recorded on the end side of zone 1, and log information (VAT_ICB with VAT) is recorded at the end of that zone 1. The end position (Pₓ₁) of zone 1 can be indicated by an address generated in correspondence with the recorded information length of “Rec 2” from end position Pₓ₀ of zone 0 (=the head of zone 1). This address (end position Pₓ₁ of zone 1) can be written in the log information (VAT_ICB with VAT) recorded at the end of zone 1. That is, the contents of the log information (VAT_ICB with VAT) reflect a change in recorded contents due to video recording processing and the like.

Note that upon initializing the DVD-R disc having the recording area shown in FIG. 5, information of the file system such as the volume structure of the UDF (Universal Disk Format) and the like, management information of the initial state are written in a head area on the lead-in side before the start position of zone 0. This management information often includes information files unique to the video recording apparatus, which are ranked as management information, in addition to the management information such as VR_MANGR.IFO, VR_MANGR.BUP, and the like described using FIG. 3 above specified in the DVD-VR standard.

The overview of the aforementioned processing (FIG. 4) will be generalized and summarized below. More specifically, processing (block ST800a) for setting the flag (in the memory of MPU 30) that designates whether or not a recording zone of interest is to be closed after recording of AV contents (realtime digital data) is provided. If this flag assumes a first state (flag “11”), the recording zone of interest is closed after recording of the AV contents (YES in block ST800c). However, if this flag is other than the first state (“11”), the zone of interest is not closed (flag “00”) or the zone is closed once per n times (n is an integer equal to or larger than 1) (flag “01” or “10”) depending on the state of the flag.

When the disc in use is a rewritable medium such as DVD-RAM, DVD-RW, or the like, and the recorded contents are to be changed by edit processing or the like, data to be processed can be updated and can be written back to the disc. By contrast, in case of a write-once medium such as DVD-R or the like, when the recorded contents on the disc are changed, or even when a file is partially changed, new data needs to be recorded again on an unrecorded area on the disc. That is, when the edit processing is applied, the updated data is not overwritten but it is incrementally written. In this case, many pieces of management information such as the management information of that file, information of the parent directory which is linked with that file management information, information of its parent directory, and the like need to be re-created, resulting in very poor efficiency.

In order to reduce such inefficiency, when recording is done on a DVD-R disc by incremental write, a special address conversion table called a VAT (Virtual Allocation Table) is to be used according to the UDF standard. By using this table, when the recorded contents of the disc are changed, only the changed data and VAT can be recorded, and the enormous quantities of data such as the information of the linked parent directory and the like need not be fully changed and incrementally written. In FIG. 5 as well, after the management information of the initial state is recorded, a VAT at that time and VAT_ICB used to identify the VAT are written as log information (VAT_ICB with VAT) at the end of the information area which is written upon initialization.

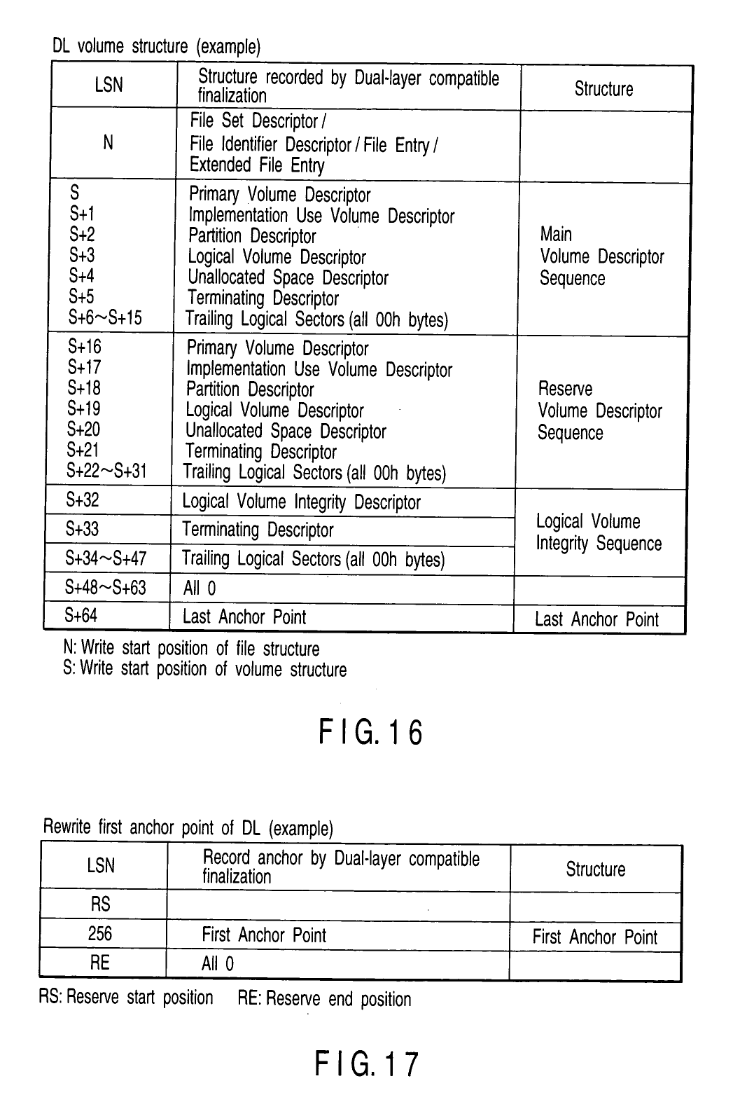

The configuration common to the single-sided, single-layer DVD-R and the single-sided, dual-layer DVD-R•DL has been described. On the DVD-R•DL, an information area for the DL volume structure and file structure is assured on the lead-out side. The “DL volume structure and file structure” on the lead-out side can be the same as the “volume structure and file structure” on the lead-in side (LSN=0 to 65), but information contents recorded in this area are different (FIG. 16 to be described later exemplifies the contents of the “DL volume structure and file structure”).

As shown in FIG. 5, an area obtained by subtracting that of information written upon initialization is a recording area that can be used to incrementally write data by video recording, edit processing, and the like. In one embodiment of the invention, a first data size assigned to save data for edit processing, and a second data size assigned for video recording can be assured in this recording area. Note that the remaining capacity can be recognized by detecting the logical address (or “Last recorded address of RZone#n” in the RMA area) which is recorded in, e.g., the file system and is recognized as the address used by bitmap information that indicates the recorded state of physical sectors or logical sectors or the management information.

FIG. 6 shows a practical example of the log information (VAT_ICB with VAT) recorded at the end of the zone in the recording area of FIG. 5. This log information can be generated by executing the processing for closing a zone (block ST809 in FIG. 4), and is configured to include the following information in numerical order of byte position BP.

That is, a descriptor tag is stored at first byte position BP=0. There are two types of tags: one type of the tag is a descriptor tag for the volume structure specified by the UDF, and other type of the tag is a descriptor tag for the file structure specified by the UDF. In the file structure for DVD-R, a VAT (Virtual Allocation Table) and VAT_ICB (Virtual Allocation Table Information Control Block) are recorded in an incremental recording mode. To virtual addresses in the incremental recording mode, the following contents are assigned. That is, virtual address=0 is used for a file set descriptor, virtual address=1 is used to an ICB root directory. Virtual addresses=2 to 255 are assigned to the DVD_RTAV directory, and file entries of files recorded under the DVD_RTAV directory. By assigning the log information (VAT_ICB with VAT) including such contents to the end of each zone, the recorded contents of each zone can be managed.

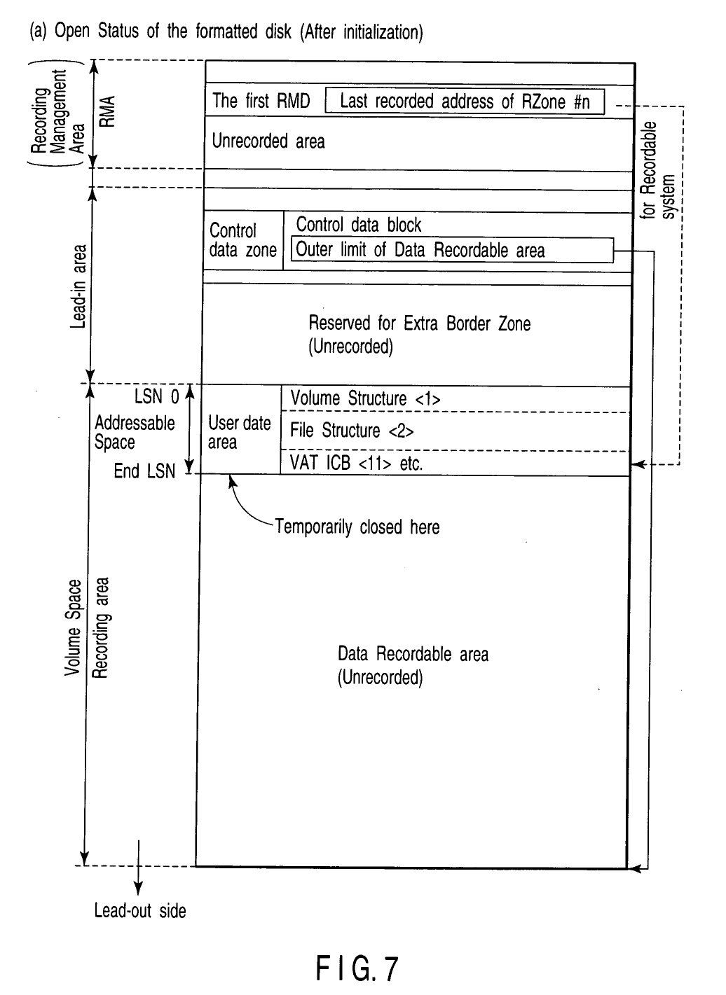

FIG. 7 is a view for explaining the state of a write-once medium (DVD-R disc or the like) after initialization. This medium has a recording management area (RMA) on the lead-in side (innermost periphery side of the disc), and control data in a lead-in area that follows the RMA, and a user data area is formed in a volume space (recordable area) that follows the lead-in area. This user data area is written with information of the volume structure, file structure, and information virtual allocation table control block (VAT_ICB), and that area (zone) is temporarily closed. New information recording is made after the closed zone toward the lead-out side. Note that the end position of the closed zone can be detected from the first RMD (the last recorded address of RZone#n) recorded in the RMA.

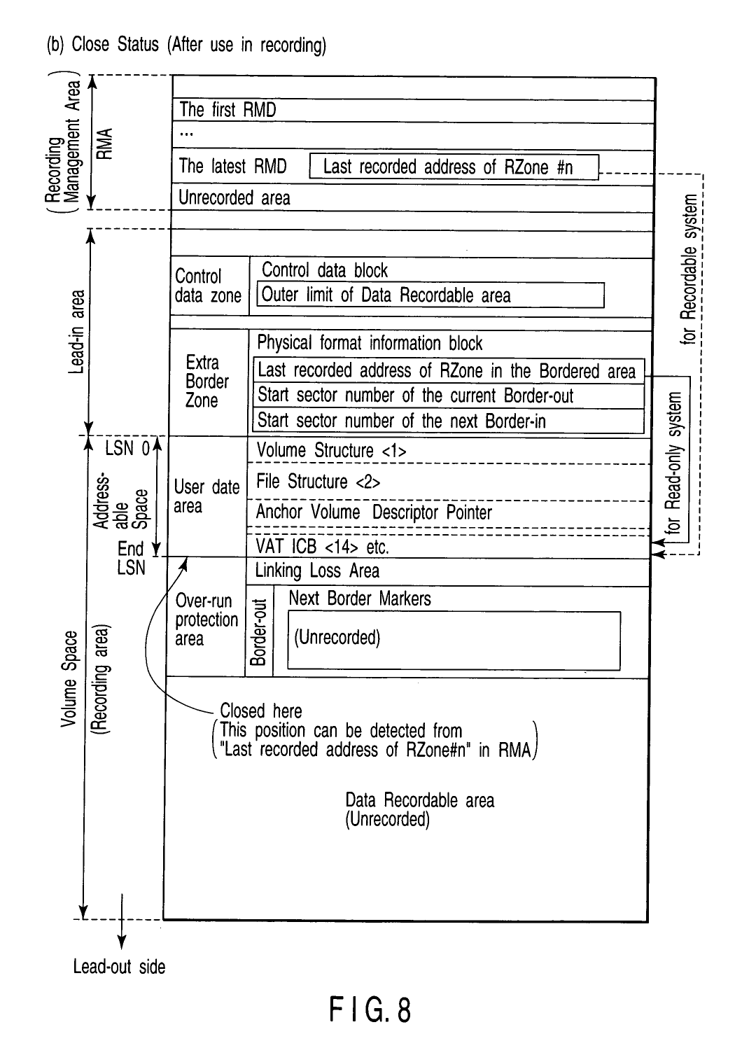

FIG. 8 is a view for explaining the state of a write-once medium used in recording after initialization. “First RMD” to “latest RMD” are written in the RMA in correspondence with the number of times of video recording, and the end position of a zone which is recorded and closed latest on the medium can be detected from the “last recorded address of RZone#n” described in the last “latest RMD”. Based on the log information (VAT_ICB with the virtual allocation table; see FIG. 6), the recorded state of the medium can be recognized.

After recording has been done on the initialized write-once medium, processing for returning this medium to the initial state can be made. This processing is premised on a zone being temporarily closed (RZone is temporarily closed after initialization (the root directory is recorded)). For example, when a medium in use (DVD-R•DL disc or the like) is used in video recording halfway through and can no longer be used due to an error in the recorded area (or when the recorded area is inhibited from being accessed and that disc is reused as a new disc, although no error has occurred), this processing can be used not to repair but to return the disc to the initial state (the state immediate after the root directory in FIG. 3 is created).

The user designates initialization by operating the remote controller or the like (not shown). In response to this designation, the “last recorded address of RZone#n (#n indicates the recorded last zone number)” in the RMA area of that disc is read to calculate the “recorded VAT_ICB” position from the position indicated by the “last recorded address of RZone#n” to the root directory. The VAT_ICB from the calculated position to the root directory is mapped on work RAM 31 in the MPU 30 in FIG. 1 to calculate the current write start position (immediately after the RZone close position) based on the “last recorded address of RZone#n” in the RMA. The VAT_ICB mapped on work RAM 31 is written at the calculated current write start position, and the RZone is closed at that position. After that, the disc can be reusable as a new disc from the RZone closed position to the end of the Volume on the lead-out side in FIG. 7 (although the capacity is smaller than a new disc).

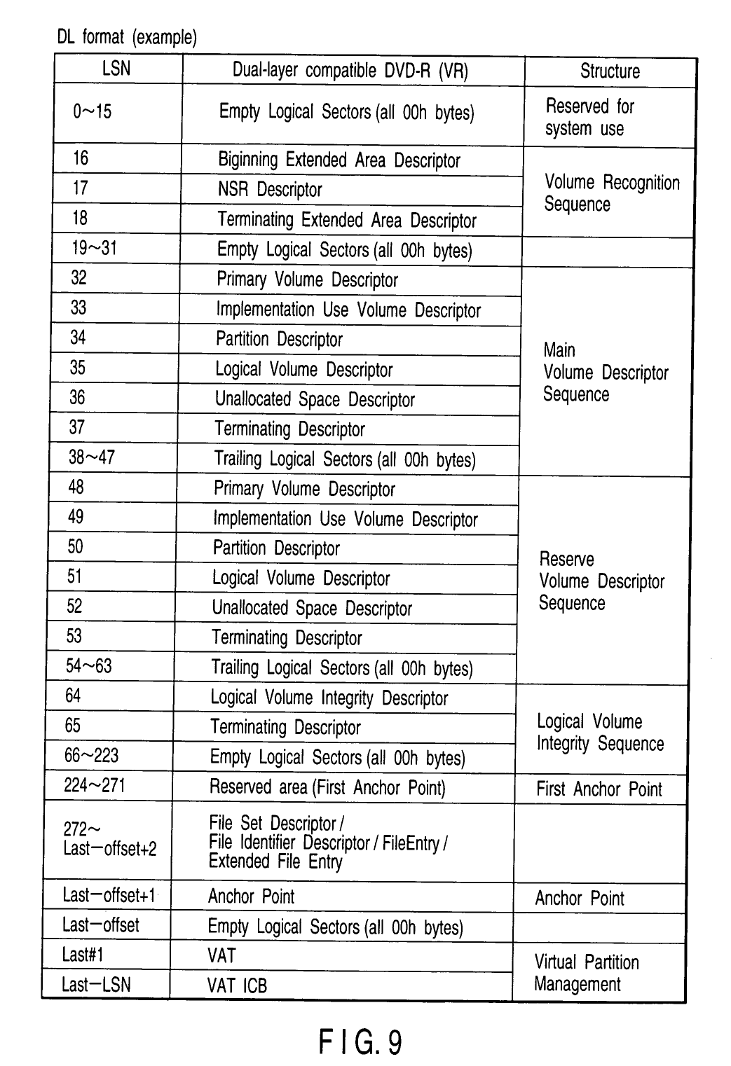

FIG. 9 is a view for explaining an example of the format of the single-sided, dual-layer DVD-R (DVD-R•DL). On the single-sided, single-layer DVD-R, the first anchor point (corresponding to an anchor volume descriptor pointer at the center of FIG. 8) is assured at logical sector number LSN=256. However, on the DVD-R•DL, an area (LSN=224 to 271) including LSN=256 is reserved for a first anchor point and the like. A “temporary anchor point” used to record information associated with the last (latest) anchor point on the disc in use is assured at a position (Last-offset+1) offset by a predetermined size from the last logical sector number (Last).

Note that an anchor point indicates one of specific sets of logical sector numbers (LSN), and is configured to record a descriptor that specifies the extent (a set of logical sectors or logical blocks) of a volume descriptor sequence (a sequence including description information.associated with a volume).

Let “N” be the last logical sector number in the addressable space. Then, anchor points in once recording mode are assigned at least at two positions of “logical sector number LSN=256”, “logical sector number LSN=N”, and “logical sector number LSN=N−256”.

Also, anchor points in the incremental recording mode (see the description of FIG. 6) are assigned at two positions of “logical sector number LSN=256” and “logical sector number LSN=N−256” (“N” is the last logical sector number in the addressable space).

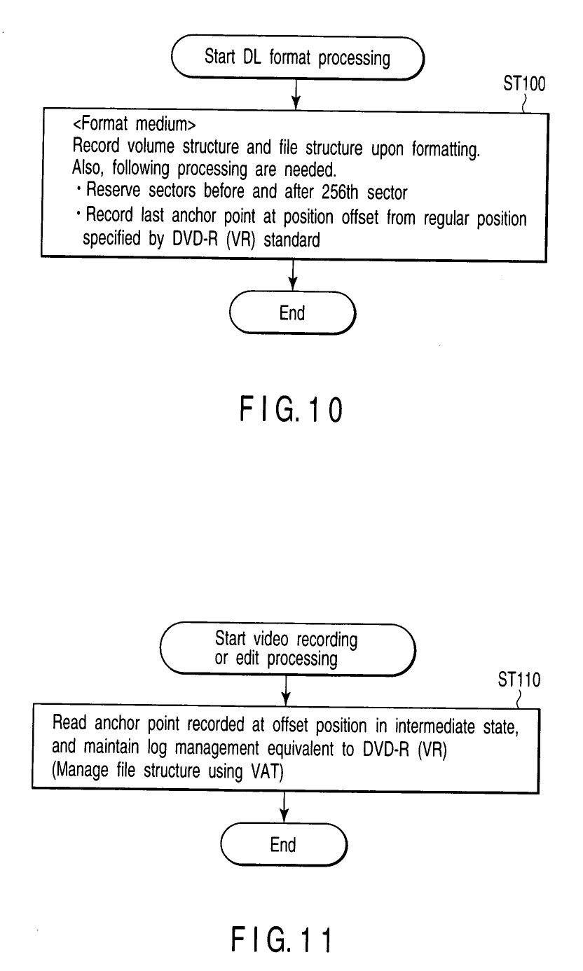

FIG. 10 is a flowchart for explaining an example of the format processing of the DVD-R•DL. When unused DVD-R•DL disc 1001 is mounted on disc drive unit 1002 in FIG. 1, the control program of MPU 30 displays, on the screen, a dialog (not shown) that inquires the user about whether or not the mounted disc is to be initialized (formatted). If the user designates to execute initialization (formatting), initialization (formatting) of the disc mounted on the drive unit starts (block ST100). With this formatting, the volume structure and file structure upon formatting are recorded on disc 1001 (see FIG. 5). In this formatting, sectors before and after LSN=256 (LSN=224 to 271 in the example of FIG. 9) are reserved, and the last anchor point (latest anchor point of the disc in use) is recorded at the position (the position of Last-offset+1 in the example of FIG. 9) from the regular position (LSN=256) specified by the DVD-R (VR) standard (of the single-sided, single-layer disc).

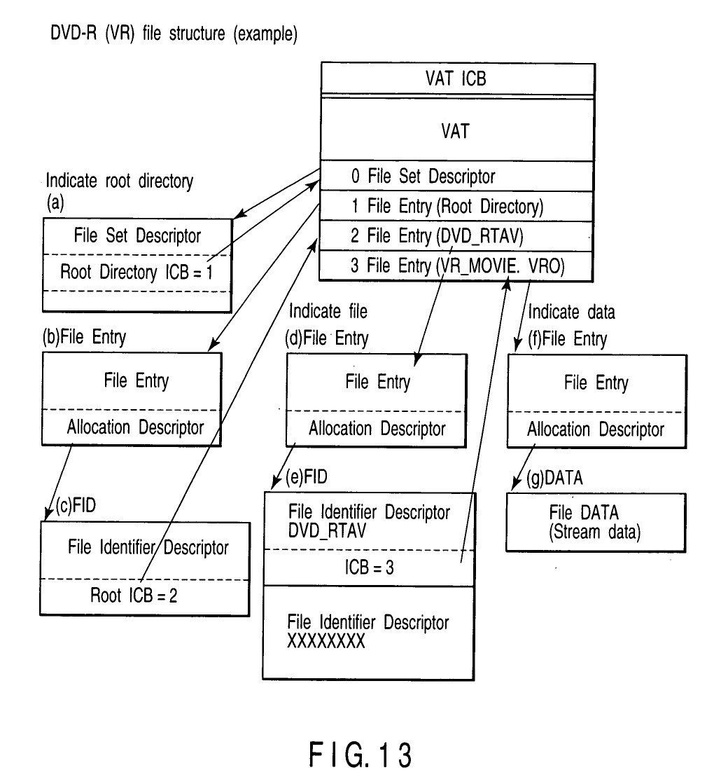

FIG. 11 is a flowchart for explaining an example of processing in the intermediate state (before finalization) in the video recording or edit processing using the DVD-R•DL. Since recording is done in the DVD-R (VR) logical format in the intermediate state of the single-sided, dual-layer (DL) disc, if the anchor point is recorded at the regular position (LSN=256), the disc cannot be distinguished from the DVD-R (VR) logical format in case of the single-sided, single-layer disc. Hence, in case of the single-sided, dual-layer (single-sided, multi-layer) disc, by recording the anchor point at the position (recording position of a temporary anchor point offset from the regular position (LSN=256) specified by the DVD-R (VR) standard, it is distinguished from DVD-R (VR) recording, and the intermediate state similar to the DVD-R (VR) logical format in case of the single-sided, single-layer disc is maintained in case of the single-sided, dual-layer (single-sided, multi-layer) disc (see FIG. 13).

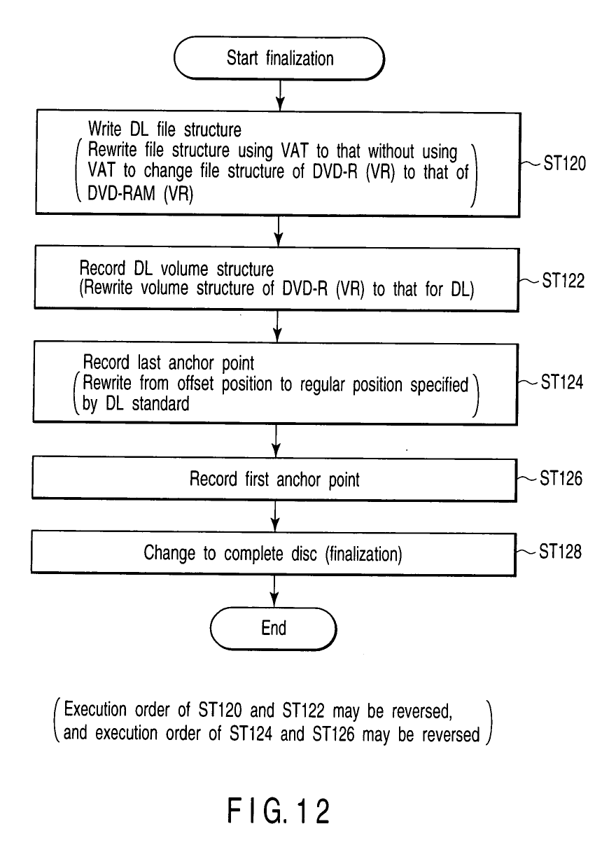

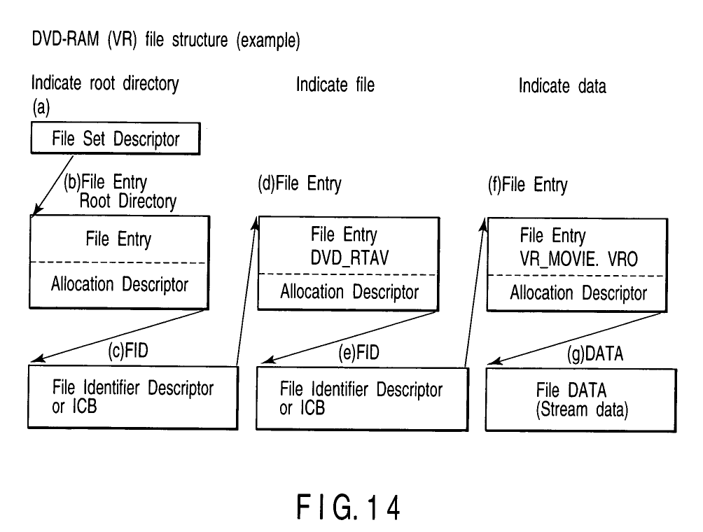

FIG. 12 is a flowchart for explaining an example of finalization processing of the DVD-R-DL. The file structure is recorded in the format according to the DL standard (by converting it from the structure shown in FIG. 13 to that shown in FIG. 14) (block ST120). Next, the volume structure is recorded while being converted into the format (FIG. 16) according to the DL standard (block ST122). The recording location of the information converted into the DL format is the area of the “DL volume and file structures” on the lead-out side in the example of FIG. 5 (the recording order of the file structure and volume structure (ST120 and ST122) may be reversed). Next, after an anchor point (the last (latest) anchor point in the recording process of the disc of interest) is recorded (block ST124), the first anchor point is recorded in the area reserved as shown in FIG. 17 to have the contents corresponding to the last anchor point (block ST126) (the recording order of the first anchor point and last anchor point (ST124 and ST126) may be reserved). Finally, the medium (DVD-R•DL) is finalized to a complete disc (block ST128).

FIG. 13 is a view for explaining an example of the file structure of the DVD-R•DL (VR mode) before finalization. On the DVD-R•DL (VR), the recorded contents in the intermediate state before finalization are managed by the “VAT” described with reference to FIG. 5, FIG. 6, and the like. That is, the allocations of the root directory, files, and data (or recorded contents corresponding to these allocations) are linked by referring to the description of the “VAT”.

More specifically, a file set descriptor of the root directory is referred to by the first (0-th) descriptor of the VAT, and the first file entry of the VAT is referred to by root directory ICB=1 of this file set descriptor. When the file entry of the root directory is referred to by the first file entry of the VAT, file identifier descriptor FID of the root directory is referred to by an allocation descriptor of this file entry, and the second file entry is referred to by ICB=2 of this FID. When a file entry of file DVD_RTAV (FIG. 3) is referred to by the second file entry of this VAT, the FID of the DVD_TRAV is referred to by an allocation descriptor of this file entry, and the third file entry of the VAT is referred to by ICB=3 of this FID. When a file entry of object VR_MOVIE.VRO (FIG. 3) is referred to by the third file entry of the VAT, file data of VR_MOVIE•VRO is referred to by an allocation descriptor of this file entry, and corresponding stream data can be accessed.

The same volume management and file management as those after finalization can be made by information management using the aforementioned “VAT” in the intermediate state of the DVD-R•DL (VR) before finalization.

FIG. 14 is a view for explaining an example of the file structure (corresponding to that of the DVD-RAM/VR mode) of the DVD-R•DL (VR mode) after finalization. The DVD-R•DL medium recorded in the DVD-R (VR) logical format rewrites the volume structure and file structure in the finalization processing so as to guarantee compatibility to a player that can play back DVD-RAM/RW (VR) media (a player that performs playback independently of the VAT) (see FIG. 16).

With this rewrite processing, respective descriptors (the file set descriptor, file identifier descriptors, allocation descriptors, and the like) include descriptions associated with the volumes or files at the link destinations. (The locations of respective descriptors can be detected from information of the anchor point stored at LSN=256.) In this way, management without using any “VAT” (information links indicated by arrows in FIG. 14) can be made in place of that which is made through the assistance of the “VAT” (information links indicated by arrows in FIG. 13).

More specifically, when a file entry of the root directory is referred to by a file-set descriptor of the root directory, file identifier descriptor FID of the root directory is referred to by an allocation descriptor of this file entry, and a file entry of file DVD_RTAV (FIG. 3) is referred to by this FID or its ICB. Then, the FID of DVD_RTAV is referred to by an allocation descriptor of this file entry, and a file entry of object VR_MOVIE•VRO (FIG. 3) is referred to by this FID or its ICB. Then, file data of VR_MOVIE•VRO is referred to by an allocation descriptor of this file entry, and corresponding stream data can be accessed.

On the complete disc after finalization of the DVD-R•DL (VR) (after the processing in block ST128 in FIG. 12), the volume management and file management that guarantee playback compatibility with a player which can play back DVD-RAM/RW (VR) media (a player which performs playback independently of the VAT) can be implemented by the aforementioned information management that is made without the assistance of the “VAT”.

FIG. 15 is a view for explaining another example of the format of the single-sided, dual-layer DVD-R (DVD-R•DL). This figure exemplifies the recorded state of the medium after the DL format processing using a description method different from FIG. 9 in association with the reserved area. After the DL format processing (before finalization), recording is done using the VAT specified by the DVD-R (VR) standard. By reserving sectors (LSN=RS to RE) including the 256th sector, information written in the temporary anchor point is written at the reserved position upon finalization of the medium (block ST100 in FIG. 10; see FIG. 17). In this way, the anchor point information to be recorded at the 256th sector can be assured on the complete disc.

FIG. 16 is a view for explaining an example of the volume structure of the single-sided, dual-layer DVD-R (DVD-R•DL) . This example shows the “file structure and volume structure” recorded by finalization corresponding to the DVD-R•DL disc. More specifically, the file structure information (file set descriptor/file identifier descriptors/file entries/extended file entries, etc: information after LSN=RE+1 in the example of FIG. 15) is written at logical sector numbers LSN=N to (S−1). Also, the volume structure information (primary volume descriptor, etc: corresponding to information after LSN=48 in the example of FIG. 15) is written at logical sector numbers LSN=S to (S+64).

FIG. 17 is a view for explaining a rewrite example of the first anchor point of the single-sided, dual-layer DVD-R (DVD-R•DL). In this example, the first anchor point information is written at LSN=256 in the reserved area (LSN=RS to RE). If the remaining area of the reserved area (LSN=RS to RE) is not used, it is padded with all “0”s. When the necessity arises in the future, another information (information of all the 2nd to last anchor points or information of some of these anchor points) can be written.

### Summary of Embodiment

(1) DVD-R•DL (dual layer) means a single-sided, dual-layer DVD medium of the DVD-R medium. The logical format of the file system specified by the DL standard assures compatibility with a player which can play back a DVD-R/RW (VR) disc in the state of a complete disc state (finalized medium).

The logical format of the DL standard specifies the state of the complete disc by the standard but does not specify that in the middle of recording. Hence, by recording using the logical format specified by the single-sided, single-layer DVD-R (VR) standard in the state in the middle of recording (intermediate state), the log information unique to the DVD-R (VR) standard can be implemented even in the intermediate state.

(2) In order to record an anchor point in the finalization processing, the anchor point write area is reserved upon formatting the single-sided, multi-layer (dual layer: DL) medium (see FIGS. 9 and 15).

(3) In the intermediate state of the single-sided, dual-layer medium, recording is done using the DVD-R (VR) logical format. However, by changing only the recording position of an anchor point (offset to the position of a temporary anchor point), the medium is distinguished from that recorded using the single-sided, single-layer DVD-R (VR) logical format (see FIGS. 9 and 15).

(4) In the finalization processing of the single-sided, dual-layer (DL) medium, the file structure (FIG. 14) and volume structure (FIGS. 16 and 17) are rewritten from recording using the VAT shown in FIG. 9 to that which does not use any VAT, thus converting the logical format to that compatible to DL.

### Effects of Embodiment

(1) DVD-R (VR) has merits that allow edit processing in one frame unit, and simultaneous video recording of bilingual broadcast, but has a demerit of poor compatibility. Hence, since one embodiment of the invention records in the intermediate state of the DL medium using a VAT (Virtual Allocation Table) specified by the DVD-R (VR) standard, log information can be recorded, and edit processing in one frame unit, simultaneous recording of bilingual broadcast, and the like can be implemented. Furthermore, since the volume structure and file structure are re-created in the format (to assign information of an anchor point at LSN=256) specified by the DL standard in the finalization processing, compatibility with a player which can play back DVD-RAM/RW (VR) media is guaranteed.

Note that the invention is not limited to the aforementioned embodiments, and various modifications may be made based on techniques available at that time without departing from the scope of the invention when it is practiced at present or in the future. For example, a single-sided, multi-layer disc can adopt a structure in which two or more recording layers are formed within the range near 0.6 mm from the surface of a DVD-specification disc prepared by adhering two 0.6-mm thick substrates, and another recording layer is formed near 0.1 mm from that surface. The invention can be carried out for the multi-layer disc with such structure (in this case, the recording position of an anchor point after finalization may be set in a reserved area other than LSN=256 as needed).

The respective embodiments may be combined as needed, and combined effects can be obtained in such case. Furthermore, the embodiments include inventions of various stages, and various inventions can be extracted by appropriately combining a plurality of constituent elements disclosed in this application. For example, even when some constituent elements are omitted from all the constituent elements disclosed in the embodiments, an arrangement from which those constituent elements are omitted can be extracted as an invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording method for digitally recording on an optical disc which comprises a single-sided, multi-layer recording area configured to include a volume and file structure area and at least one recording zone between a lead-in area and a lead-out area, comprising:
performing formatting that assures a reserved area for writing anchor point information in the volume and the file structure area;
assuring a temporary anchor point area that stores anchor point information in an intermediate state before finalization at a position other than the reserved area; and
recording digital information in the at least one recording zone.

2. A recording method for digitally recording on an optical disc which comprises a single-sided, multi-layer recording area configured to include a volume and file structure area and at least one recording zone between a lead-in area and a lead-out area, comprising:
performing formatting that assures a reserved area for writing anchor point information in the volume and the file structure area;
assuring a temporary anchor point area that stores anchor point information in an intermediate state before finalization at a position other than the reserved area; and
recording the anchor point information in the temporary anchor point area in the intermediate state.

3. A recording method for digitally recording on an optical disc which comprises a single-sided, multi-layer recording area configured to include a volume and file structure area and at least one recording zone between a lead-in area and a lead-out area, comprising:
performing formatting that assures a reserved area for writing anchor point information in the volume and the file structure area;
assuring a temporary anchor point area that stores anchor point information in an intermediate state before finalization at a position other than the reserved area;
recording the anchor point information in the temporary anchor point area in the intermediate state; and
writing the anchor point information in the temporary anchor point area at a predetermined position in the reserved area.

4. A recording apparatus using the optical disc configured to perform recording by a method of claim 1, comprising:
a unit configured to perform formatting that assures a reserved area for writing anchor point information in the area of the volume structure and the file structure;
a unit configured to assure a temporary anchor point area that stores anchor point information in an intermediate state before finalization at a position other than the reserved area; and
a unit configured to record digital information in the at least one recording zone.

5. A recording apparatus using the optical disc configured to perform recording by a method of claim 2, comprising:
a unit configured to perform formatting that assures a reserved area for writing anchor point information in the area of the volume structure and the file structure;
a unit configured to assure a temporary anchor point area that stores anchor point information in an intermediate state before finalization at a position other than the reserved area;
a unit configured to record the anchor point information in the temporary anchor point area in the intermediate state; and
a unit configured to record digital information in the at least one recording zone.

6. A recording apparatus using the optical disc configured to perform recording by a method of claim 3, comprising:
a unit configured to perform formatting that assures a reserved area for writing anchor point information in the area of the volume structure and the file structure;
a unit configured to assure a temporary anchor point area that stores anchor point information in an intermediate state before finalization at a position other than the reserved area;
a unit configured to record the anchor point information in the temporary anchor point area in the intermediate state;
a unit configured to write the anchor point information in the temporary anchor point area at a predetermined position in the reserved area; and
a unit configured to record digital information in the at least one recording zone.

7. A playback apparatus using the optical disc which undergoes recording by a method of claim 1, comprising:
a unit configured to reproduce digital information recorded in the volume and the file structure area; and
a unit configured to play back digital information recorded in the at least one recording zone.

8. A playback apparatus using the optical disc which undergoes recording by a method of claim 2, comprising:
a unit configured to reproduce digital information recorded in the volume and the file structure area;
a unit configured to play back digital information recorded in the at least one recording zone; and
a unit configured to reproduce the anchor point information from the temporary anchor point area in the intermediate state.

9. A playback apparatus using the optical disc which undergoes recording by a method of claim 3, comprising:
a unit configured to reproduce digital information recorded in the volume and the file structure area;
a unit configured to play back digital information recorded in the at least one recording zone; and
a unit configured to reproduce the anchor point information from the temporary anchor point area in the intermediate state.
